(19) United States
(12) Patent Application Publication
(10) Pub. No.: US 2025/0079986 A1
(43) Pub. Date: Mar. 6, 2025

(54) Controllers for DC-To-DC Converters, and Associated Systems and Methods

(71) Applicant: Analog Devices, Inc., Wilmington, MA (US)

(72) Inventors: Bin ZHANG, Durham, NC (US); Hua CHEN, Monterey, CA (US)

(21) Appl. No.: 18/783,792

(22) Filed: Jul. 25, 2024

Related U.S. Application Data
(60) Provisional application No. 63/517,110, filed on Aug. 1, 2023.

(51) Int. Cl. H02M 3/158; H02M 1/00

(52) U.S. Cl. CPC H02M 3/158; H02M 1/0029

(57) ABSTRACT

A method for controlling a direct-current-to-direct-current (DC-to-DC) converter includes (a) causing the DC-to-DC converter to operate in a constant frequency operating mode, (b) determining that a duty cycle of a first switching device of the DC-to-DC converter has crossed a first threshold value, and (c) in response to the duty cycle of the first switching device of the DC-to-DC converter crossing the first threshold value, causing the DC-to-DC converter to reduce switching frequency and switch from operating in the constant frequency operating mode to operating in a constant off-time operating mode.

### RELATED APPLICATIONS

This application claims benefit of U.S. Provisional Patent Application No. 63/517,110, filed on Aug. 1, 2023, which is incorporated herein by reference.

### BACKGROUND

Switching power converters are widely used in electronic devices, such as to provide a regulated electric power source. A switching power converter is configured such that its solid-state power switching devices do not continuously operate in their linear states; instead, the switching devices repeatedly switch between their on-states and off-states. One type of a switching power converter is a direct-current-to-direct-current (DC-to-DC) converter which converts one direct-current (DC) voltage to another DC voltage, or converts one DC current to another DC current.

### BRIEF DESCRIPTION OF THE DRAWINGS

FIG. 1 is a graph illustrating one example of duty cycle in a direct-current-to-direct-current (DC-to-DC) converter.

FIG. 2 is a graph illustrating one example of a constant frequency operating mode of a DC-to-DC converter.

FIG. 3 is a graph illustrating one example of a constant off-time operating mode of a DC-to-DC converter.

FIG. 4 is a schematic diagram of an electric system including a DC-to-DC converter with a controller configured to cause the DC-to-DC converter to automatically switch between a constant frequency operating mode and a constant off-time operating mode, according to an embodiment.

FIG. 5 is a graph of switching frequency versus duty cycle illustrating one example of operation of the FIG. 4 controller.

FIG. 6 is a state diagram illustrating another example of operation of the FIG. 4 controller.

FIG. 7 is a schematic diagram of one embodiment of the FIG. 4 electric system where a power stage of the DC-to-DC converter has a boost topology.

FIG. 8 includes three graphs illustrating one example of operation of the FIG. 7 DC-to-DC converter.

FIG. 9 is a schematic diagram of one embodiment of the FIG. 4 electric system where a power stage of the DC-to-DC converter has a buck-boost topology.

FIG. 10 includes three graphs illustrating one example of operation of the FIG. 9 DC-to-DC converter.

FIG. 11 is a schematic diagram of one embodiment of the FIG. 4 electric system where a power stage of the DC-to-DC converter has a buck topology.

FIG. 12 includes three graphs illustrating one example of operation of the FIG. 11 DC-to-DC converter.

FIG. 13 is a block diagram of one embodiment of the controller of FIG. 4.

FIG. 14 includes seven graphs illustrating one example of operation of the FIG. 4 DC-to-DC converter with an embodiment of FIG. 13 controller.

FIG. 15 includes seven graphs illustrating another example of operation of the FIG. 4 DC-to-DC converter with an embodiment of FIG. 13 controller.

FIG. 16 is a schematic diagram of one possible embodiment of an oscillator of the FIG. 13 controller.

FIG. 17 includes six graphs illustrating one example of operation of the FIG. 16 oscillator.

FIG. 18 includes six graphs illustrating another example of operation of the FIG. 16 oscillator.

FIG. 19 is a schematic diagram of one possible embodiment of a voltage control module of the FIG. 13 controller.

### DETAILED DESCRIPTION OF THE EMBODIMENTS

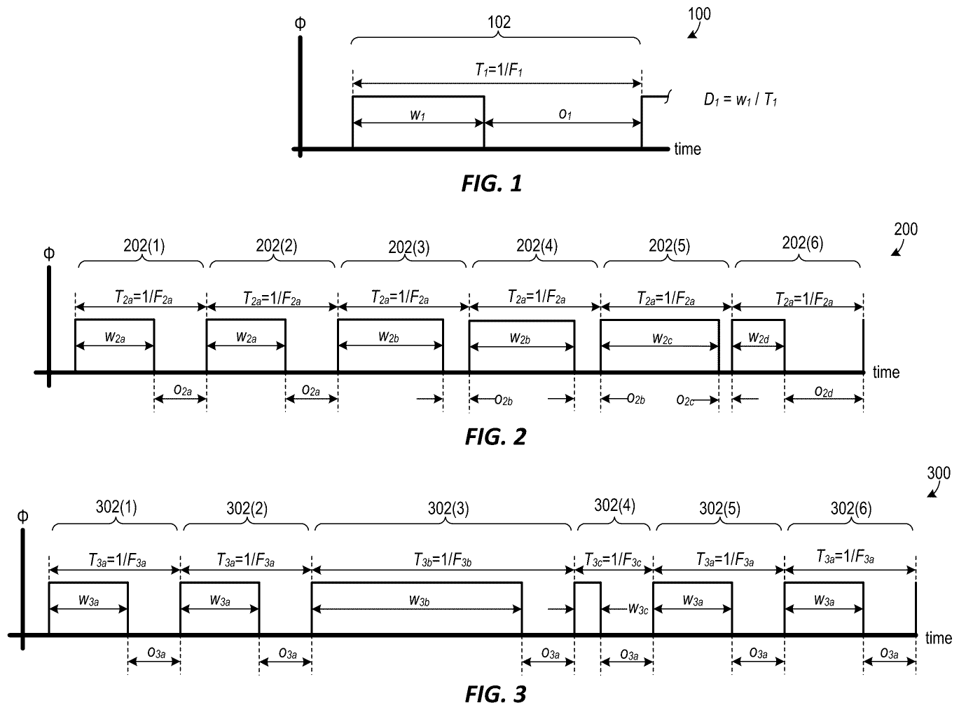

One direct-current-to-direct-current (DC-to-DC) converter parameter is duty cycle (D), which refers to a portion of a switching cycle that a control switching device, sometimes referred to as an active switching device, is in its on-state (conductive state). A control switching device of a DC-to-DC converter is a switching device of the DC-to-DC converter where duty cycle of the switching device may be modulated to regulate one or more parameters of the DC-to-DC converter, such as input voltage magnitude, input current magnitude, output voltage magnitude, and/or output current magnitude. As one example of duty cycle of a DC-to-DC converter, consider FIG. 1, which is a graph 100 of a control signal ϕ magnitude versus time during a switching cycle 102 of the DC-to-DC converter. In the FIG. 1 example, control signal ϕ drives a control switching device of a DC-to-DC converter (not shown), and the control switching device operates in its on-state when control signal ϕ is asserted. Conversely, the control switching device operates in its off-state (non-conductive state) when control signal ϕ is de-asserted. Switching cycle 102 has period Ti, which is equal to the inverse of a switching frequency F₁ of the DC-to-DC converter in switching cycle 102. Control signal ϕ is asserted for a duration w₁, and control signal ϕ is de-asserted for a duration o₁, in switching cycle 102. Consequently, the control switching device is on for a duration of w₁ in switching cycle 102, and the control switching device is off for a duration of o_{f} in switching cycle 102. As such, a duty cycle D₁ of the control switching device in the FIG. 1 example is given by EQN. 1 below.

$${D}_{1} = \frac{{w}_{1}}{{T}_{1}} \qquad ( EQN . 1 )$$

A constant frequency operating mode of a DC-to-DC converter is an operating mode where a switching frequency of the DC-to-DC converter is fixed. A period of each switching cycle of the DC-to-DC converter is also necessarily fixed in the constant frequency operating mode because switching period is the inverse of switching frequency, as mentioned above. Duty cycle may be modulated in the constant frequency operating mode by modulating control switch on-time within each switching cycle, to regulate one or more parameters of the DC-to-DC converter. Consequently, control switching device on-time and control switching device off-time may vary among switching cycles, in the constant frequency operating mode.

FIG. 2 is graph 200 of a control signal ϕ magnitude versus time illustrating one example of a DC-to-DC converter operating in a constant frequency operating mode. In the FIG. 2 example, a control signal ϕ drives a control switching device of a DC-to-DC converter (not shown), and (a) the control switching device operates in its on-state when control signal ϕ is asserted, and (b) the control switching device operates in its off state when control signal ϕ is de-asserted. FIG. 2 illustrates several example consecutive switching cycles 202 of the DC-to-DC converter operating in the constant frequency operating mode. In this document, specific instances of an item may be referred to by use of a numeral in parentheses (e.g. switching cycle 202(1)) while numerals without parentheses refer to any such item (e.g. switching cycles 202). The switching power converter operates at a constant switching frequency F₂ₐ, and each switching cycle 202 therefore has a period T₂ₐ equal to the inverse of constant switching frequency F₂ₐ. Control switching device on-time and off-time, however, vary among some switching cycles 202, such as to maintain desired regulation of one or more DC-to-DC converter parameters as DC-to-DC converter operating conditions change.

For example, in each of switching cycles 202(1) and 202(2), the control switching device is in its on-state for a duration of w₂ₐ, and the control switching device is in its off-state for a duration of o₂ₐ. The duty cycle of the control switching device is therefore w₂ₐ/T₂ₐ in each of switching cycles 202(1) and 202(2). In each of switching cycles 202(3) and 202(4), though, the control switching device is in its on-state for a duration of w_{2b}, the control switching device is in its off-state for a duration of o_{2b}, and the control switching device therefore has a duty cycle of w_{2b}/T₂ₐ. Duration w_{2b} is greater than duration w₂ₐ, and the duty cycle of the control switching device in switching cycles 202(3) and 202(4) is therefore greater than the duty cycle of the control switching device in switching cycles 202(1) and 202(2). In switching cycle 202(5), the control switching device is in its on-state for a duration of w_{2c}, the control switching device is in its off-state for a duration of o_{2c}, and the duty cycle of the control switching device is w_{2c}/T₂ₐ. Duration w₂ₑ is greater than either of durations w₂ₐ and w_{2b}, and the duty cycle of the control switching device in switching cycle 202(5) is therefore greater than the duty cycle of the control switching device in any of switching cycles 202(1)-202(4). Duty cycle of the control switching device in switching cycle 202(6), in contrast, in smaller than the duty cycle of the control switching device in any of switching cycles 202(1)-202(5). Specifically, in switching cycle 202(6), the control switching device is in its on-state for a relatively small duration of w_{2d}, the control switching device is in its off-state for a relatively long duration of o_{2d}, and the duty cycle of the control switching device is w_{2d}/T₂ₐ.

A constant off-time operating mode of a DC-to-DC converter is an operating mode where an off-time of a control switching device of the DC-to-DC converter is fixed, where off-time refers to the duration of each switching cycle where the control switching device is in its off-state. Duty cycle may be modulated in the constant off-time operating mode by modulating control switching device on-time in each switching cycle, to regulate one or more parameters of the DC-to-DC converter. Consequently, DC-to-DC converter switching frequency may vary among switching cycles, in the constant off-time operating mode.

FIG. 3 is graph 300 of a control signal q) magnitude versus time illustrating one example of a DC-to-DC converter operating in a constant off-time operating mode. Similar to the FIG. 2 example, in the FIG. 3 example, a control signal q) drives a control switching device of a DC-to-DC converter (not shown), and (a) the control switching device operates in its on-state when control signal ϕ1 is asserted, and (b) the control switching device operates in its off state when control signal ϕ1 is de-asserted. FIG. 3 illustrates several example consecutive switching cycles 302 of the switching power converter in the constant off-time operating mode. The switching power converter operates with the control switching device having a constant off-time of a duration o₃a in each switching cycle 302. Control switching device on-time and DC-to-DC converter switching frequency, however, vary among some switching cycles 302, such as to maintain desired regulation of one or more DC-to-DC converter parameters as DC-to-DC operating conditions change.

For example, in each of switching cycles 302(1), 302(2), 302(5), and 302(6), the control switching device is in its on-state for a duration of w₃ₐ, the period is T₃ₐ, and the switching power converter has a switching frequency of F₃ₐ, where switching frequency of F₃ₐ is the inverse of period T₃ₐ. The duty cycle of the control switching device is therefore w₃ₐ/T₃a in each of switching cycles 302(1), 302(2), 302(5), and 302(6). In switching cycle 302(3), though, the control switching device is in its on-state for a relatively long duration of w_{3b} to achieve a larger duty cycle of w_{3b}/T_{3b}, such as in response to a change in operating conditions of the DC-to-DC converter. Consequently, switching cycle 302(3) has a relatively large period T₃b and a relatively small switching frequency F₃b. In switching cycle 302(4), in contrast, the control switching device is in its on-state for a relatively short duration of w_{3c} to achieve a smaller duty cycle of w_{3c}/T₃ₑ, such as in response to another change in operating conditions of the DC-to-DC converter. Consequently, switching cycle 302(4) has a relatively small period T_{3c} and a relatively large switching frequency F₃c.

A ratio of output voltage Vₒᵤₜ to input voltage Vᵢₙ, of a DC-to-DC converter is typically a function of duty cycle D. For example, EQNS. 2, 3, and 4 specify a ratio of output voltage Vₒᵤₜ to input voltage Vᵢₙ as a function of duty cycle for a boost DC-to-DC converter, a buck-boost DC-to-DC converter, and a buck DC-to-DC converter, respectively, assuming continuous conduction operation.

$$\frac{{V}_{o u t}}{{V}_{i n}} = \frac{1}{1 - D} ( Boost ) \qquad ( EQN . 2 )$$

$$\frac{{V}_{o u t}}{{V}_{i n}} = \frac{- D}{1 - D} ( Buck - Boost ) \qquad ( EQN . 3 )$$

$$\frac{{V}_{o u t}}{{V}_{i n}} = D ( Buck ) \qquad ( EQN . 4 )$$

As evident from EQNS. 2-4, duty cycle D must be large to obtain a large ratio of output voltage Vₒᵤₜ to input voltage Vᵢₙ. However, a maximum value of duty cycle D is limited in a DC-to-DC converter operating in a constant frequency operating mode to allow time for switching devices to change states as well as time for a controller of the DC-to-DC converter to obtain and process data. Therefore, a ratio of output voltage Vₒᵤₜ to input voltage Vᵢₙ of a DC-to-DC converter operating in a constant frequency operating mode is limited by a maximum permissible value of duty cycle D. Such limitation may be problematic in applications where a large ratio of Vₒᵤₜ/Vᵢₙ, is required, such as in applications where Vᵢₙ is abnormally low due to a large load placed on a power supply providing input voltage Vᵢₙ, low temperature of a battery providing input voltage Vᵢₙ, etc.

In contrast, duty cycle may be essentially unlimited in a DC-to-DC converter operating in a constant off-time operating mode, which enables the DC-to-DC converter to achieve a large ratio of Vₒᵤₜ/Vᵢₙ. However, switching frequency may significantly vary in the constant off-time operating mode, such as discussed above with respect to FIG. 3. Potential variation in switching frequency may be undesirable, for example, because it may require a large inductor and large filtering components to ensure acceptable operation at low switching frequency. Additionally, variation in switching frequency of a DC-to-DC converter may complicate efforts to achieve electromagnetic compatibility (EMC) of the DC-to-DC converter with other devices.

Disclosed herein are new controllers for DC-to-DC converters and associated systems and methods which at least partially mitigate the problems discussed above. Certain embodiments of the new controllers, systems, and methods automatically switch an operating mode of a DC-to-DC converter between a constant frequency operating mode and a constant off-time operating mode at least partially based on duty cycle of a control switching device of the DC-to-DC converter, such as in response to duty cycle of the control switching device crossing a threshold value. For example, certain embodiments are configured to (a) cause a DC-to-DC converter to operate in a fixed frequency operating mode when a duty cycle of a control switching device of the DC-to-DC converter does not exceed a maximum permissible duty cycle in the constant frequency operating mode and (b) cause the DC-to-DC converter to operate in a constant off-time operating mode when a duty cycle of the control switching device exceeds the maximum permissible constant duty cycle in the constant frequency operating mode. Accordingly, certain embodiments cause a DC-to-DC converter to operate in a constant frequency operating mode except when operation in a constant off-time operating mode is required to achieve regulation of one or more DC-to-DC converter parameters, thereby promoting stability associated with constant frequency operation while enabling a large ratio of output voltage to input voltage to be realized when required.

Furthermore, some embodiments of the new controller, systems, and methods support current mode control, such as peak current mode control, to promote high performance line and load regulation. In these embodiments, a slope compensation signal is optionally provided in a constant frequency operating mode to enable stable operation, e.g., operation without subharmonic oscillation, with duty cycle greater than fifty percent. Additionally, some embodiments change generation of a slope compensation signal, such as by maintaining the slope compensation signal at a constant value, in response to duty cycle of the control switching device crossing a threshold value, such that the slope compensation signal does not affect DC-to-DC converter operation when the DC-to-DC converter is operating in a fixed off-time operating mode.

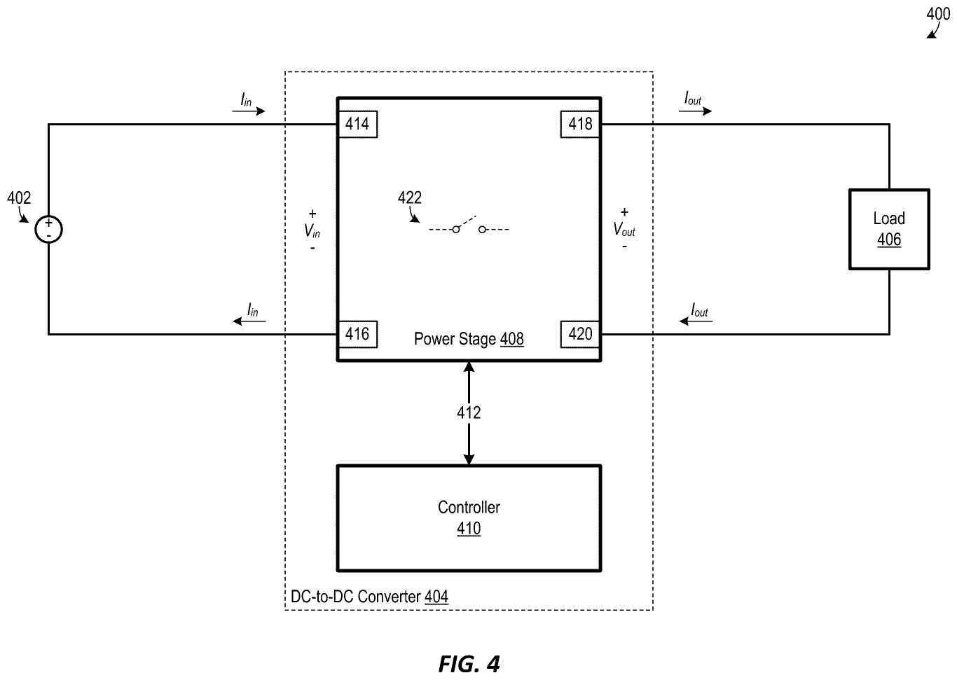

FIG. 4 is a schematic diagram of an electric system 400 including an electric power source 402, a DC-to-DC converter 404, and an electric load 406. DC-to-DC converter 404 includes a power stage 408 and a controller 410, where controller 410 is one embodiment of the new controllers disclosed herein. Controller 410 is communicatively coupled 412 to power stage 408, and controller 410 controls operation of power stage 408, as discussed below. Power stage 408 includes a first input port 414, a second input port 416, a first output port 418, and a second output port 420. In some embodiments, first input port 414, second input port 416, first output port 418 and second output port 420 are discrete elements, such as integrated circuit pins, integrated circuit solder balls or solder tabs, electrical terminals, etc. In some other embodiments, first input port 414, second input port 416, first output port 418 and second output port 420 are respective electric nodes that optionally encompass a plurality of electrical conductors. Power stage 408 also includes a control switching device 422, which is symbolically shown in FIG. 4 by a switch formed of dashed lines.

Electric power source 402 is electrically coupled between first input port 414 and second input port 416, and electric load 406 is electrically coupled between first output port 418 and second output port 420. Power stage 408 is configured to convert an input voltage Vᵢₙ, between first input port 414 and second input port 416 to an output voltage Vₒᵤₜ between first output port 418 and second output port 420 (or vice versa), in response to control signals (not shown) from controller 410. Additionally, power stage 408 is configured to convert an input current Iᵢₙ flowing between first input port 414 and second input port 416 to an output current Iₒᵤₜ flowing between first output port 418 and second output port 420 (or vice versa), in response to control signals (not shown) from controller 410.

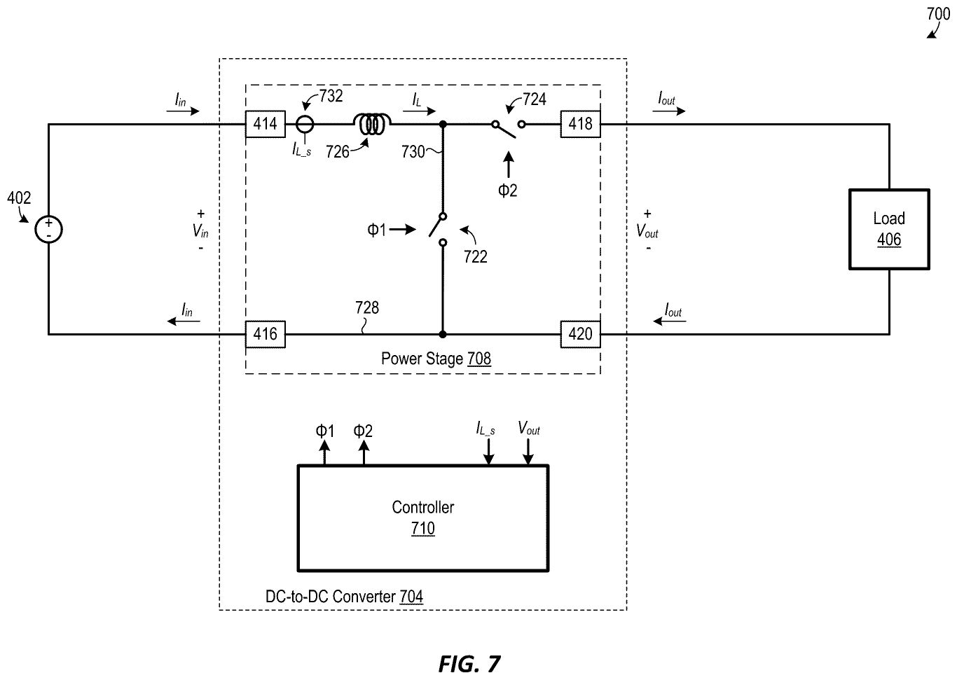

Power stage 408 may have either a non-isolated topology or an isolated topology. In some embodiments where power stage 408 has a non-isolated topology, first input port 414 and first output port 418 are part of a common electric node. In some other embodiments where power stage 408 has a non-isolated topology, second input port 416 and second output port 420 are part of a common electric node. In particular embodiments, power stage 408 has one of a boost topology, a buck-boost topology, or a buck topology, such as discussed below with respect to FIGS. 7-12. However, it is understood that power stage 408 is not limited to having one of the aforementioned topologies. For example, power stage 408 could alternately have a flyback topology, a forward topology, a Ćuk topology, a SEPIC topology, a Zeta topology, etc.

Controller 410 is formed, for example, of analog electronic circuitry and/or digital electronic circuitry. Although controller 410 is depicted as being a single element, controller 410 may be formed of multiple sub-elements that need not be co-packaged. Additionally, controller 410 could partially or fully integrated with one or more other elements, such as with power stage 408. Furthermore, in some alternate embodiments, controller 410 is at least partially located external to DC-to-DC converter 404. For example, in particular alternate embodiments, controller 410 is split into a local portion and a remote portion, where the local portion is within DC-to-DC converter 404 and the remote portion is external to DC-to-DC converter 404.

Certain embodiments of controller 410 are configured to generate one or more control signals (not shown) to control duty cycle of control switching device 422 of power stage 408 to regulate one or more parameters of DC-to-DC converter 404. Examples of such parameters that may be regulated include, but are not limited to, one or more of magnitude of input voltage Vᵢₙ, magnitude of output voltage Vₒᵤₜ, magnitude of input current Iᵢₙ and magnitude of output current Iₒᵤₜ. Importantly, controller 410 is further configured to automatically switch an operating mode of DC-to-DC converter 404 between a constant frequency operating mode and a constant off-time operating mode at least partially based on duty cycle of control switching device 422, such as in response to duty cycle of control switching device 422 crossing a threshold value. In certain embodiments, controller 410 is configured to switch the operating mode of DC-to-DC converter 404 between the constant frequency operating mode and the constant off-time operating mode at least partially by extending a period of an oscillator (not shown in FIG. 4) of controller 410, e.g., by pausing operation of the oscillator.

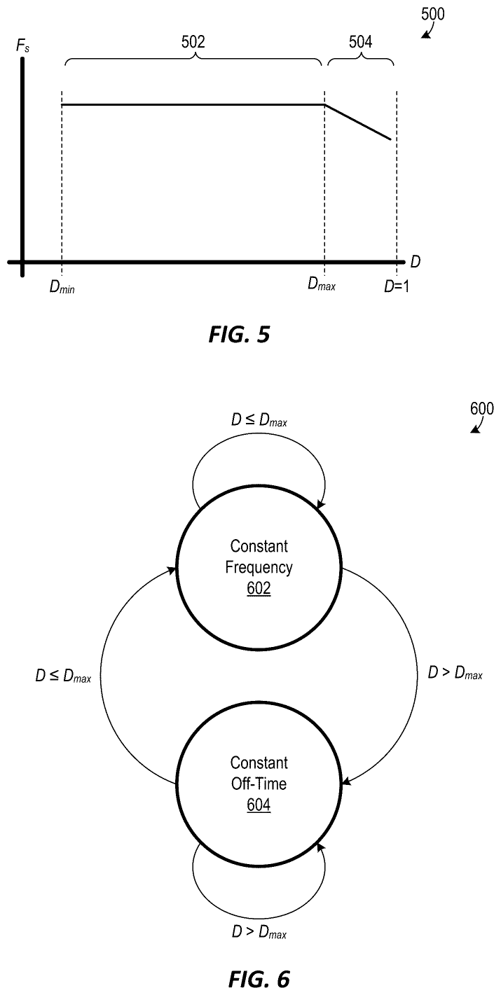

For example, FIG. 5 is a graph 500 of switching frequency Fₛ of DC-to-DC converter 404 versus duty cycle D of control switching device 422 illustrating one example of possible operation of controller 410. Three values of duty cycle D are labeled along the X-axis of graph 500, i.e., D=Dₘᵢₙ, D=Dₘₐₓ, and D=1. Dₘᵢₙ is a minimum permissible value of D, such as a minimum value of D required for reliable operation of DC-to-DC converter 404. Dₘₐₓ is a maximum permissible value of D when DC-to-DC converter 404 is operating in a constant frequency operate mode, and D=1 corresponds to one hundred percent duty cycle of control switching device 422. Controller 410 is configured to cause DC-to-DC converter 404 to operate in a constant frequency operating mode 502, as shown by switching frequency Fₛ being constant, whenever D is at least as great as Dₘᵢₙ and D does not exceed Dₘₐₓ. Additionally, controller 410 is configured to cause DC-to-DC converter 404 to operate in a constant off-time operating mode 504 when D exceeds Dₘₐₓ, as shown in FIG. 5 by switching frequency Fₛ decreasing with increasing value of D above Dₘₐₓ.

FIG. 6 is a state diagram 600, which illustrates another example of possible operation of controller 410. State diagram includes a state 602 and a state 604. In state 602, controller 410 generates control signals to cause DC-to-DC converter 404 to operate in a constant frequency operating mode, and in state 604, controller 410 generates control signals to cause DC-to-DC converter 404 to operate in a constant off-time operating mode. As illustrated in FIG. 6, controller 410 operates in state 602 when D is less than or equal to Dₘₐₓ. Additionally, controller 410 switches from state 602 to state 604 in response to D rising above Dₘₐₓ, and controller 410 remains in state 604 as long as D remains greater than Dₘₐₓ. Controller 410 switches from state 604 to state 602 in response to D falling to Dₘₐₓ or below.

FIG. 7 is a schematic diagram of an electric system 700, which is an embodiment of electric system 400 (FIG. 4) where DC-to-DC converter 404 is embodied by a DC-to-DC converter 704. Power stage 408 of DC-to-DC converter 404 is embodied by a power stage 708 in DC-to-DC converter 704. Power stage 708 has a boost topology. Specifically, power stage 708 includes a control switching device 722, a freewheeling switching device 724, and an inductor 726. Second input port 416 and second output port 420 are part of a common electric node 728 in power stage 708. Control switching device 722, which is an embodiment of control switching device 422 (FIG. 4), is electrically coupled between a switching electric node 730 and common electric node 728. Inductor 726 is electrically coupled between first input port 414 and switching electric node 730, and freewheeling switching device 724 is electrically coupled between switching electric node 730 and first output port 418. Each of control switching device 722 and freewheeling switching device 724 includes, for example, one or more transistors and driver circuitry for driving the transistors. Control switching device 722 is controlled by a control signal ϕ1, and freewheeling switching device 724 is controlled by a control signal ϕ2. Power stage 708 optionally further includes current sense circuitry 732 configured to generate a signal I_{L_s} representing magnitude of current I_{L} flowing through inductor 726.

Controller 410 is embodied by a controller 710 in DC-to-DC converter 704, and controller 710 is configured to generate control signals ϕ1 and ϕ2. Controller 710 is configured to generate control signal ϕ1 to control switching of control switching device 722 to regulate one or more parameters of DC-to-DC converter 704. In certain embodiments, such as illustrated in FIG. 7, controller 710 receives one or more of output voltage Vₒᵤₜ and signal I_{L}_s as inputs. Controller 710 is configured to generate control signal ϕ2 to cause freewheeling switching device 724 to provide a path for current I_{L} flowing through inductor 726 when control switching device 722 is in its off-state. In some alternate embodiments, freewheeling switching device 724 is replaced by a diode and control signal ϕ2 is omitted. Controller 710 is configured to automatically switch an operating mode of DC-to-DC converter 704 between a constant frequency operating mode and a constant off-time operating mode at least partially based on duty cycle of control switching device 722, such as in response to duty cycle of control switching device 722 crossing a threshold value, e.g., in a manner discussed above with respect to FIG. 5 or FIG. 6.

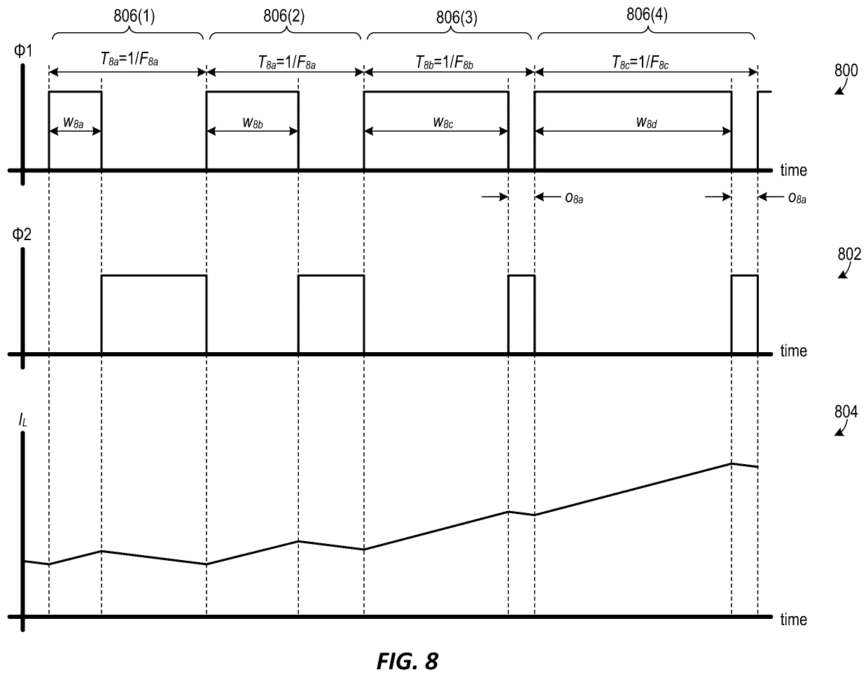

FIG. 8 includes three graphs 800, 802, and 804 collectively illustrating one example of operation of DC-to-DC converter 704. Graph 800 is of control signal ϕ1 versus time, graph 802 is control signal σ2 versus time, and graph 804 is of inductor current I_{L} versus time. All three graphs 800, 802, and 804 have a common time base. FIG. 8 assumes that (a) control switching device 722 operates in its on-state when control signal ϕ1 is asserted and (b) control switching device 722 operates in its off-state when control signal ϕ1 is de-asserted. Additionally, FIG. 8 assumes that (a) freewheeling switching device 724 operates in its on-state when control signal ϕ2 is asserted and (b) freewheeling switching device 724 operates in its off-state when control signal ϕ2 is de-asserted. However, control switching device 722 and freewheeling switching device 724 may respond to respective control signals ϕ1 and ϕ2 in a different manner. Additionally, control signals ϕ1 and ϕ2 may have different polarities than those illustrated in FIG. 8.

FIG. 8 depicts several example consecutive switching cycles 806 of DC-to-DC converter 704. Controller 710 generates control signal ϕ1 such that DC-to-DC converter 704 operates in a constant frequency operating mode in switching cycles 806(1) and 806(2). DC-to-DC converter 704 accordingly has a constant switching frequency of F₈ₐ, which is equal to the inverse of a period T₈ₐ, in switching cycles 806(1) and 806(2). However, respective on-times w₈ₐ and w_{8b} of control switching device 722 in switching cycles 806(1) and 806(2) differ, such as in response to operating conditions of DC-to-DC converter 704 changing between switching cycles 806(1) and 806(2).

Controller 710 generates control signal ϕ1 such that DC-to-DC converter 704 operates in a constant off-time operating mode in switching cycles 806(3) and 806(4), such as in response to duty cycle of control switching device 722 increasing beyond a maximum permissible duty value in the constant frequency operating mode. Control switching device 722 accordingly has a constant off-time of o₈ₐ in switching cycles 806(3) and 806(4). However, respective on-times w₈ₑ and w_{8d} of control switching device 722 in switching cycles 806(3) and 806(4) differ, such as in response to operating conditions of DC-to-DC converter 704 varying among switching cycles 806(3) and 806(4). Consequently, switching cycles 806(3) and 806(4) have different respective switching frequencies of F_{8b} and F₈ₑ, which are the inverse of periods T_{8b} and T_{8c}, respectively. As evident when comparing switching cycles 806(3) and 806(4) to switching cycles 806(1) and 806(2), switching frequency in the constant off-time operating mode is less than switching frequency in the constant frequency operating mode.

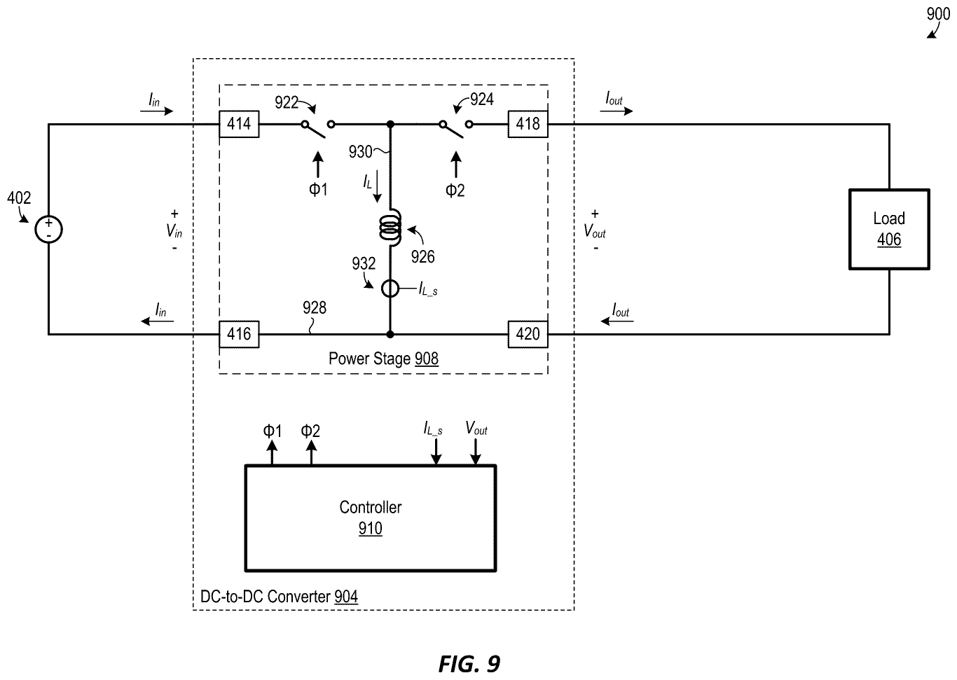

FIG. 9 is a schematic diagram of an electric system 900, which is an embodiment of electric system 400 (FIG. 4) where DC-to-DC converter 404 is embodied by a DC-to-DC converter 904. Power stage 408 of DC-to-DC converter 404 is embodied by a power stage 908 in DC-to-DC converter 904. Power stage 908 has a buck-boost topology. Specifically, power stage 908 includes a control switching device 922, a freewheeling switching device 924, and an inductor 926. Second input port 416 and second output port 420 are part of a common electric node 928 in power stage 908. Control switching device 922, which is an embodiment of control switching device 422 (FIG. 4), is electrically coupled between first input port 414 and a switching electric node 930. Inductor 926 is electrically coupled between switching electric node 930 and common electric node 928, and freewheeling switching device 924 is electrically coupled between switching electric node 930 and first output port 418. Each of control switching device 922 and freewheeling switching device 924 includes, for example, one or more transistors and driver circuitry for driving the transistors. Control switching device 922 is controlled by a control signal ϕ1, and freewheeling switching device 924 is controlled by a control signal ϕ2. Power stage 908 optionally further includes current sense circuitry 932 configured to generate a signal I_{L_s} representing magnitude of current I_{L} flowing through inductor 926.

Controller 410 is embodied by a controller 910 in DC-to-DC converter 904, and controller 910 is configured to generate control signals ϕ1 and ϕ2. Controller 910 is configured to generate control signal ϕ1 to control switching of control switching device 922 to regulate one or more parameters of DC-to-DC converter 904. In certain embodiments, such as illustrated in FIG. 9, controller 910 receives one or more of output voltage Vₒᵤₜ and signal I_{L_s} as inputs. Controller 910 is configured to generate control signal ϕ2 to cause freewheeling switching device 924 to provide a path for current I_{L} flowing through inductor 926 when control switching device 922 is in its off-state. In some alternate embodiments, freewheeling switching device 924 is replaced by a diode and control signal ϕ2 is omitted. Controller 910 is configured to automatically switch an operating mode of DC-to-DC converter 904 between a constant frequency operating mode and a constant off-time operating mode at least partially based on duty cycle of control switching device 922, such as in response to duty cycle of control switching device 922 crossing a threshold value, e.g., in a manner discussed above with respect to FIG. 5 or FIG. 6. Polarity of output voltage Vₒᵤₜ will be opposite of polarity of input voltage Vᵢₙ, in DC-to-DC converter 904.

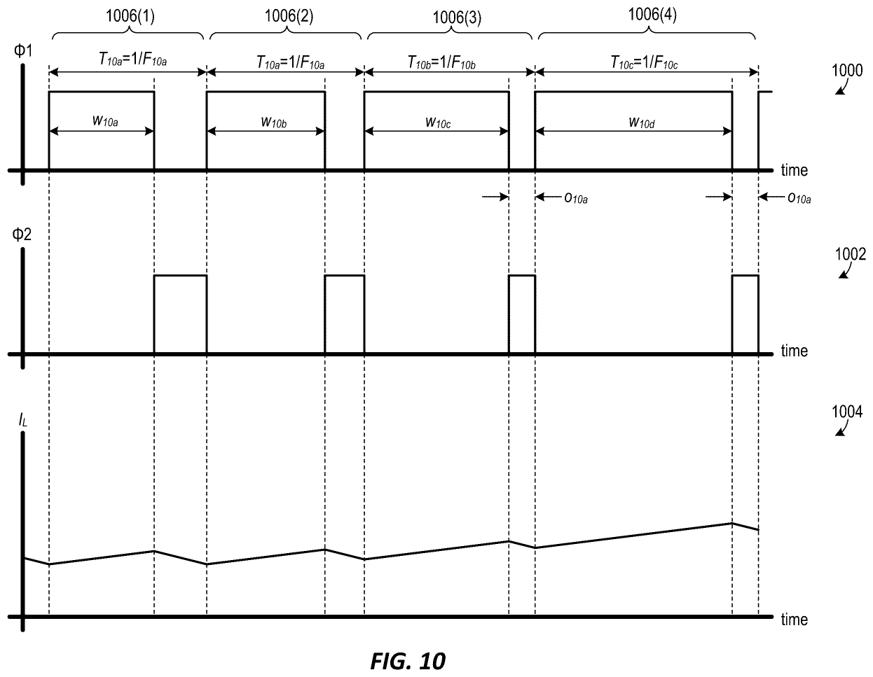

FIG. 10 includes three graphs 1000, 1002, and 1004 collectively illustrating one example of operation of DC-to-DC converter 904 in an application where magnitude of output voltage Vₒᵤₜ is greater than magnitude of input voltage Vᵢₙ. Graph 1000 is of control signal ϕ1 versus time, graph 1002 is control signal σ2 versus time, and graph 1004 is of inductor current I_{L} versus time. All three graphs 1000, 1002, and 1004 have a common time base. FIG. 10 assumes that (a) control switching device 922 operates in its on-state when control signal ϕ1 is asserted and (b) control switching device 922 operates in its off-state when control signal ϕ1 is de-asserted. Additionally, FIG. 10 assumes that (a) freewheeling switching device 924 operates in its on-state when control signal ϕ2 is asserted and (b) freewheeling switching device 924 operates in its off-state when control signal ϕ2 is de-asserted. However, control switching device 922 and freewheeling switching device 924 may respond to respective control signals ϕ1 and ϕ2 in a different manner. Additionally, control signals ϕ1 and ϕ2 may have different polarities than those illustrated in FIG. 10.

FIG. 10 depicts several example consecutive switching cycles 1006 of DC-to-DC converter 904. Controller 910 generates control signal ϕ1 such that DC-to-DC converter 904 operates in a constant frequency operating mode in switching cycles 1006(1) and 1006(2). DC-to-DC converter 904 accordingly has a constant switching frequency of F₁₀ₐ, which is equal to the inverse of a period T₁₀ₐ, in switching cycles 1006(1) and 1006(2). However, respective on-times w₁₀ₐ and w_{10b} of control switching device 922 in switching cycles 1006(1) and 1006(2) differ, such as in response to operating conditions of DC-to-DC converter 904 changing between switching cycles 1006(1) and 1006(2).

Controller 910 generates control signal ϕ1 such that DC-to-DC converter 904 operates in a constant-off time operating mode in switching cycles 1006(3) and 1006(4), such as in response to duty cycle of control switching device 922 increasing beyond a maximum permissible duty value in the constant frequency operating mode. Control switching device 922 accordingly has a constant off-time of o₁₀ₐ in switching cycles 1006(3) and 1006(4). However, respective on-times w_{10c} and w_{10d} of control switching device 922 in switching cycles 1006(3) and 1006(4) differ, such as in response to operating conditions of DC-to-DC converter 904 varying among switching cycles 906(3) and 906(4). Consequently, switching cycles 906(3) and 906(4) have different respective switching frequencies of F_{10b} and F_{10c}, which are the inverse of periods T_{10b} and T_{10c}, respectively. As evident when comparing switching cycles 1006(3) and 1006(4) to switching cycles 1006(1) and 1006(2), switching frequency in the constant off-time operating mode is less than switching frequency in the constant frequency operating mode.

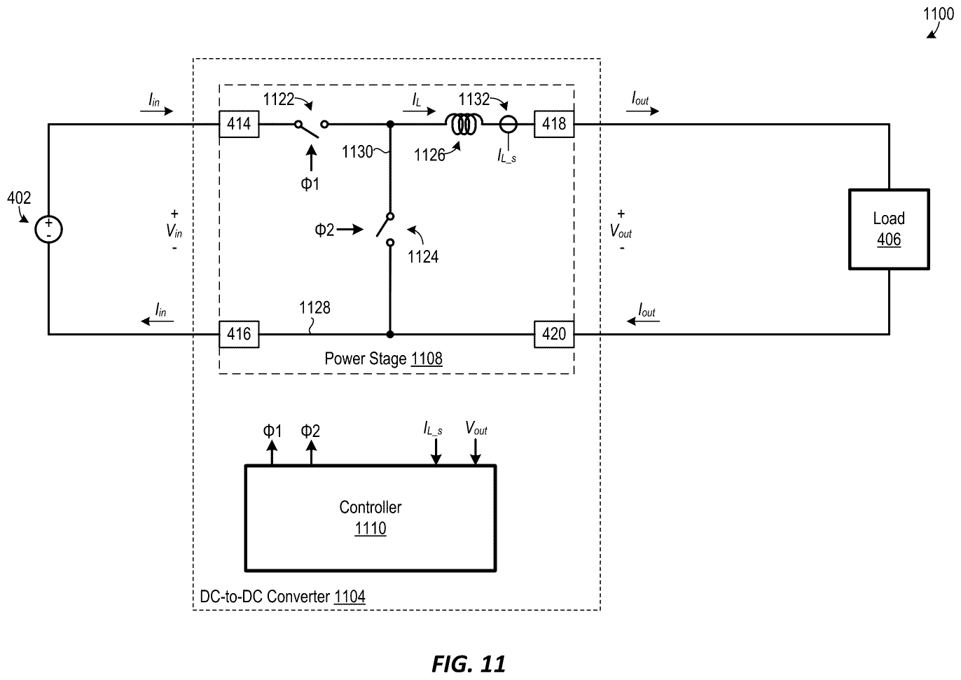

FIG. 11 is a schematic diagram of an electric system 1100, which is an embodiment of electric system 400 (FIG. 4) where DC-to-DC converter 404 is embodied by a DC-to-DC converter 1104. Power stage 408 of DC-to-DC converter 404 is embodied by a power stage 1108 in DC-to-DC converter 1104. Power stage 1108 has a buck topology. Specifically, power stage 1108 includes a control switching device 1122, a freewheeling switching device 1124, and an inductor 1126. Second input port 416 and second output port 420 are part of a common electric node 1128 in power stage 1108. Control switching device 1122, which is an embodiment of control switching device 422 (FIG. 4), is electrically coupled between first input port 414 and a switching electric node 1130. Inductor 1126 is electrically coupled between switching electric node 1130 and first output port 418, and freewheeling switching device 1124 is electrically coupled between switching electric node 1130 and common electric node 1128. Each of control switching device 1122 and freewheeling switching device 1124 includes, for example, one or more transistors and driver circuitry for driving the transistors. Control switching device 1122 is controlled by a control signal ϕ1, and freewheeling switching device 1124 is controlled by a control signal ϕ2. Power stage 1108 optionally further includes current sense circuitry 1132 configured to generate a signal I_{L_s} representing magnitude of current I_{L} flowing through inductor 1126.

Controller 410 is embodied by a controller 1110 in DC-to-DC converter 1104, and controller 1110 is configured to generate control signals ϕ1 and ϕ2. Controller 1110 is configured to generate control signal ϕ1 to control switching of control switching device 1122 to regulate one or more parameters of DC-to-DC converter 1104. In certain embodiments, such as illustrated in FIG. 11, controller 1110 receives one or more of output voltage Vₒᵤₜ and signal I_{L_s} as inputs. Controller 1110 is configured to generate control signal ϕ2 to cause freewheeling switching device 1124 to provide a path for current I_{L} flowing through inductor 1126 when control switching device 1122 is in its off-state. In some alternate embodiments, freewheeling switching device 1124 is replaced by a diode and control signal ϕ2 is omitted. Controller 1110 is configured to automatically switch an operating mode of DC-to-DC converter 1104 between a constant frequency operating mode and a constant off-time operating mode at least partially based on duty cycle of control switching device 1122, such as in response to duty cycle of control switching device 1122 crossing a threshold value, e.g., in a manner discussed above with respect to FIG. 5 or FIG. 6.

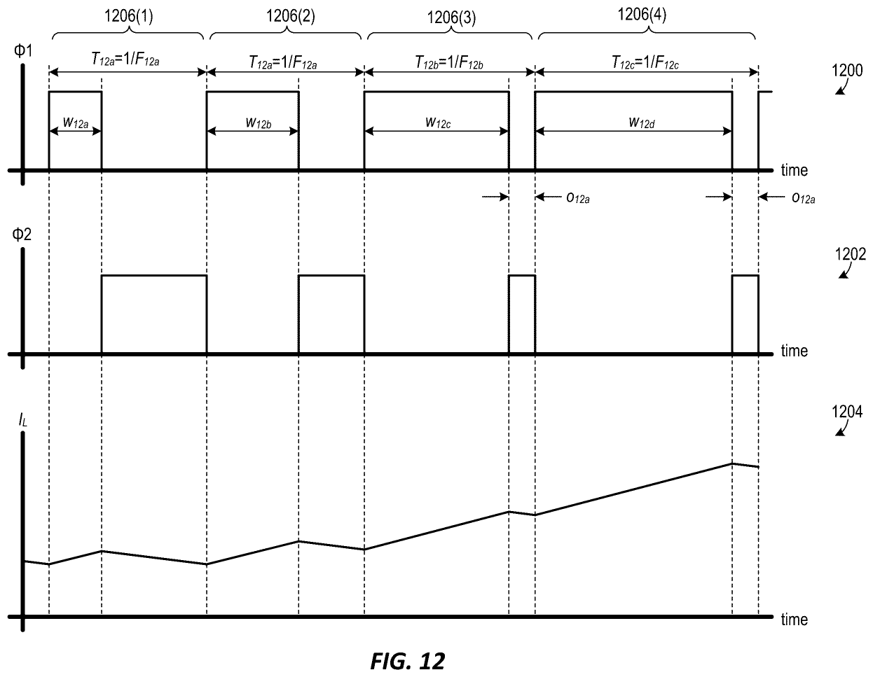

FIG. 12 includes three graphs 1200, 1202, and 1204 collectively illustrating one example of operation of DC-to-DC converter 1104. Graph 1200 is of control signal ϕ1 versus time, graph 1202 is control signal ϕ2 versus time, and graph 1204 is of inductor current I_{L} versus time. All three graphs 1200, 1202, and 1204 have a common time base. FIG. 12 assumes that (a) control switching device 1122 operates in its on-state when control signal σ1 is asserted and (b) control switching device 1122 operates in its off-state when control signal ϕ1 is de-asserted. Additionally, FIG. 12 assumes that (a) freewheeling switching device 1124 operates in its on-state when control signal ϕ2 is asserted and (b) freewheeling switching device 1124 operates in its off-state when control signal ϕ2 is de-asserted. However, control switching device 1122 and freewheeling switching device 1124 may respond to respective control signals ϕ1 and ϕ2 in a different manner. Additionally, control signals ϕ1 and ϕ2 may have different polarities than those illustrated in FIG. 12.

FIG. 12 depicts several example consecutive switching cycles 1206 of DC-to-DC converter 1104. Controller 1110 generates control signal ϕ1 such that DC-to-DC converter 1104 operates in a constant frequency operating mode in switching cycles 1206(1) and 1206(2). DC-to-DC converter 1104 accordingly has a constant switching frequency of F₁₂ₐ, which is equal to inverse of a period T₁₂ₐ, in switching cycles 1206(1) and 1206(2). However, respective on-times w₁₂ₐ and w_{12b} of control switching device 1122 in switching cycles 1206(1) and 1206(2) differ, such as in response to operating conditions of DC-to-DC converter 1104 changing between switching cycles 1206(1) and 1206(2).

Controller 1110 generates control signal ϕ1 such that DC-to-DC converter 1104 operates in a constant off-time operating mode in switching cycles 1206(3) and 1206(4), such as in response to duty cycle of control switching device 1122 increasing beyond a maximum permissible constant-frequency duty value in the constant frequency operating mode. Control switching device 1122 accordingly has a constant off-time of o₁₂ₐ in switching cycles 1206(3) and 1206(4). However, respective on-times w_{12c} and w_{12d} of control switching device 1122 in switching cycles 1206(3) and 1206(4) differ, such as in response to operating conditions of DC-to-DC converter 1104 varying among switching cycles 1206(3) and 1206(4). Consequently, switching cycles 1206(3) and 1206(4) have different respective switching frequencies of F_{12b} and F_{12c}, which are the inverse of periods T_{12b} and T_{12c}, respectively. As evident when comparing switching cycles 1206(3) and 1206(4) to switching cycles 1206(1) and 1206(2), switching frequency in the constant off-time operating mode is less than switching frequency in the constant frequency operating mode.

Referring again to FIG. 4, certain embodiments of controller 410 are configured to support current mode control, i.e., to control switching of control switching device 422 at least partially based on magnitude of current flowing through an inductor of power stage 408, such as magnitude of inductor current I_{L} of FIG. 7, 9, or 11. For example, in certain embodiments, control switching device 422 is caused to operate in its off state in response to magnitude of current flowing through an inductor of power stage 408 reaching a threshold value. In these embodiments, controller 410 optionally includes a slope compensation module (not shown in FIG. 4) configured to generate a slope compensation signal to enable stable operation of DC-to-DC converter 404 with duty cycle of control switching device 422 in excess of fifty percent, in a constant frequency operating mode of DC-to-DC converter 404. Slope compensation is not required for stable operation when DC-to-DC converter 404 is operating in a constant off-time operating mode. Accordingly, particular embodiments of controller 410 are configured to change operation of the slope compensation module when DC-to-DC converter 404 switches from a constant frequency operating mode to a constant off-time operating mode. For example, some embodiments of controller 410 are configured to pause operation of the slope generation module when DC-to-DC converter 404 switches from the constant frequency operating mode to the constant off-time operating mode, thereby maintaining the slope compensation signal at a constant value while DC-to-DC converter 404 operates in its constant off-time operating mode. The constant value of the slope compensation signal is, for instance, the most-recent value of the slope compensation signal before DC-to-DC converter 404 switched from its constant frequency operating mode to its constant off-time operating mode.

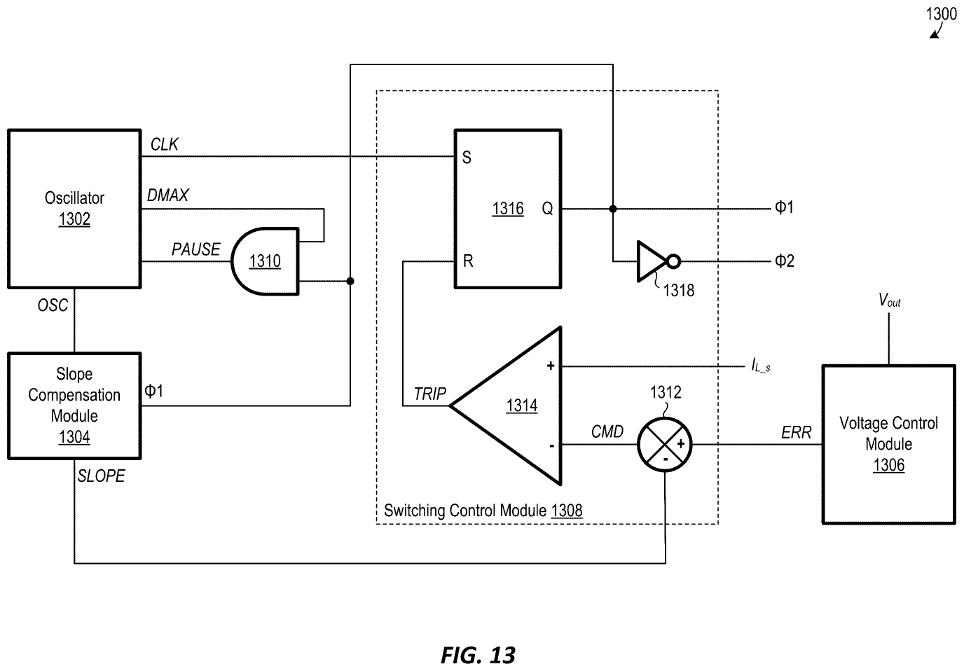

FIG. 13 is a block diagram of a controller 1300, which is one possible embodiment of controller 410 of DC-to-DC converter 404 which generates control signals σ1 and σ2, such as for use by power stage 708 (FIG. 7), power stage 908 (FIG. 9), or power stage 1108 (FIG. 11). However, it is understood that controller 410 could be embodied in other manners without departing from the scope hereof. Furthermore, controller 410 need not be capable of supporting all features of controller 1300.

Controller 1300 includes an oscillator 1302, a slope compensation module 1304, a voltage control module 1306, a switching control module 1308, and a mode change module 1310. Oscillator 1302 is configured to generate an oscillator signal OSC and a clock signal CLK, where clock signal CLK is optionally derived from oscillator signal OSC. Additionally, oscillator 1302 is configured to assert a duty cycle signal DMAX in each switching cycle in response to a maximum permissible duty cycle of control switching device 422 having been exceeded. Oscillator signal OSC is, for example, a ramp signal, and slope compensation module 1304 is configured to generate a slope compensation signal SLOPE in response to oscillator signal OSC and σ1. Slope compensation signal SLOPE is, for example, a linear or non-linear slope signal, such as a ramp signal. Voltage control module 1306 is configured to generate an error signal ERR, for example, that is proportional to, or is integral-proportional to, a difference between a magnitude of output voltage Vₒᵤₜ and a reference voltage, where the reference voltage is, for example, a desired value of output voltage Vₒᵤₜ, or a scaled value of the desired value of output voltage Vow.

Switching control module 1308 includes an amplifier 1312, a comparator 1314, a flip-flop 1316, and an inverter 1318. An output of flip-flop 1316 is control signal ϕ1, and flip-flop 1316 is set by assertion of clock signal CLK signal by oscillator 1302. Accordingly, control signal ϕ1 is asserted in response to assertion of clock signal CLK. Inverter 1318 generates control signal ϕ2 by inverting control signal ϕ1, such that control signal ϕ2 is complementary to control signal ϕ11. Some embodiments of switching control module 1308 additionally include one or more elements (not shown) to insert deadtime between consecutive assertion of controls signals ϕ1 and σ2, to ensure that there is no shoot-through, i.e., simultaneous conduction of control switching device 422 and a freewheeling switching device, such as freewheeling switching device 724, 924, or 1124.

Amplifier 1312 is configured to generate a command signal CMD proportional to a difference between error signal ERR and slope compensation signal SLOPE. Comparator 1314 receives both command signal CMD and signal I_{L_s} as inputs, where signal I_{L_s} represents magnitude current flowing through an inductor of power stage 408. In some embodiments where power stage 408 has a boost topology, a buck-boost topology, or a buck topology, signal I_{L_s} is generated by current sense circuitry 732 (FIG. 7), current sense circuitry 932 (FIG. 9), or current sense circuitry 1132 (FIG. 11), respectively. Comparator 1314 asserts a signal TRIP in response to signal I_{L_s} reaching command signal CMD, and assertion of signal TRIP resets flip-flop 1316 and thereby de-asserts control signal ϕ1. Therefore, magnitude of inductor current I_{L} reaching command signal CMD in a given switching cycle of DC-to-DC converter 404 terminates on-time of control switching device 422 in the switching cycle.

Mode change module 1310 receives each of duty cycle signal DMAX and control signal ϕ1 as inputs, and mode change module 1310 asserts a signal PAUSE in response to each of the aforementioned inputs being simultaneously asserted. As such, mode change module 1310 asserts signal PAUSE in a given switching cycle in response to control switching device 422 being in its on-state and when the maximum permissible duty cycle of control switching device 422 is reached in the switching cycle. Assertion of signal PAUSE causes oscillator 1302 to change its operation, such as by extending a period of oscillator 1302, thereby causing DC-to-DC converter 404 to change from its constant frequency operating mode to its constant off-time operating mode. For example, in particular embodiments, oscillator 1302 pauses its operation in response to assertion of signal PAUSE, resulting in (a) assertion of clock signal CLK being delayed and (b) magnitude of oscillator signal OSC being maintained at a constant value equal to the last value of the oscillator signal before assertion of signal PAUSE. Slope compensation module 1304 also changes its operation in response to assertion of signal PAUSE, such as in response to magnitude of oscillator signal OSC being maintained at a constant value. For example, in certain embodiments, slope compensation signal SLOPE is maintained at a constant value equal to its last value before assertion of signal PAUSE, in response to assertion of signal PAUSE. In some alternate embodiments, slope compensation module 1304 directly receives signal PAUSE, and slope compensation module 1304 pauses generation of slope compensation signal SLOPE in response to assertion of signal PAUSE.

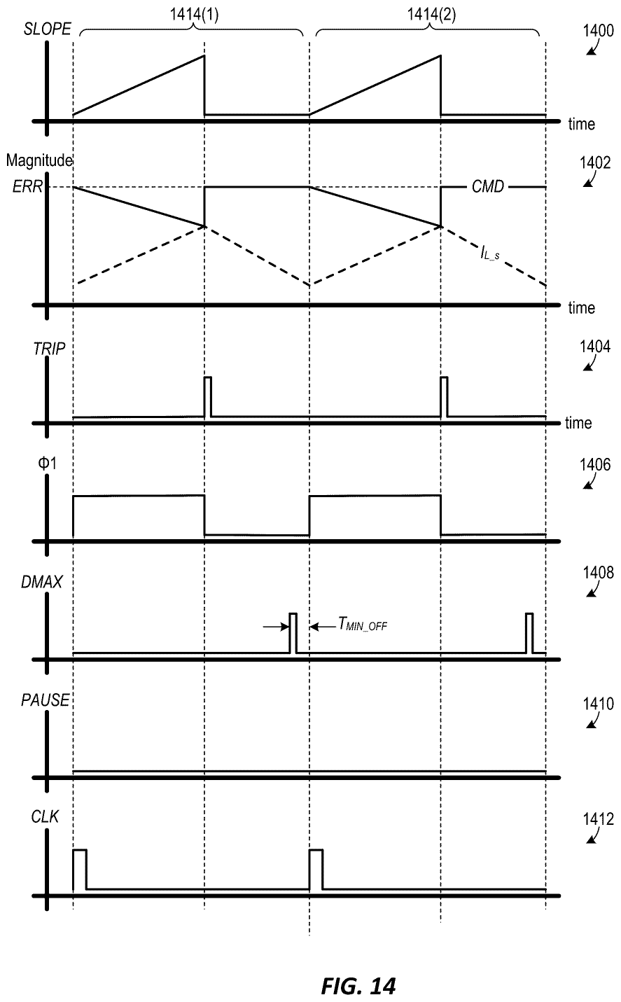

FIG. 14 includes seven graphs 1400, 1402, 1404, 1406, 1408, 1410, and 1412 collectively illustrating two consecutive switching cycles 1414 in one example of operation of DC-to-DC converter 404 including an embodiment of controller 1300. Graph 1400 is of slope compensation signal SLOPE versus time, and graph 1402 is of magnitude versus time. Graph 1402 includes a curve representing command signal CMD, a curve representing signal I_{L_s}, and a curve representing error signal ERR. It can be seen from graphs 1400 and 1402 that command signal CMD is equal to error signal ERR minus slope compensation signal SLOPE. Graph 1404 is of signal TRIP versus time, and graph 1406 is of control signal ϕ1 versus time. Graph 1408 is of duty cycle signal DMAX versus time. It should be noted that oscillator 1302 asserts signal duty cycle signal DMAX near the end of each switching cycle 1414. A duration T_{MIN_OFF}, which is a minimum permissible off-time of control switching device 422 in each switching cycle 1414, is inserted between DMAX rising edge and CLK rising edge. Graph 1410 is of signal PAUSE versus time, and graph 1412 is of clock signal CLK versus time. It should be noted that duty cycle of control switching device 422 is less than the maximum permissible duty cycle of control switching device 422, in the FIG. 14 example. Specifically, magnitude of signal I_{L_s} reaches magnitude of command signal CMD before assertion of duty cycle signal DMAX in each switching cycle 1414. As such, magnitude of current flowing through the inductor of power stage 408 reaches a threshold value defined by command signal CMD before exceeding a maximum permissible duty cycle of control switching device 422, in each switching cycle 1414. Consequently, control signal (1 and duty cycle signal DMAX are never simultaneously asserted, and signal PAUSE is therefore not asserted, in the FIG. 14 example. As a result, DC-to-DC converter 404 operates solely in its constant frequency operating mode in the example of FIG. 14.

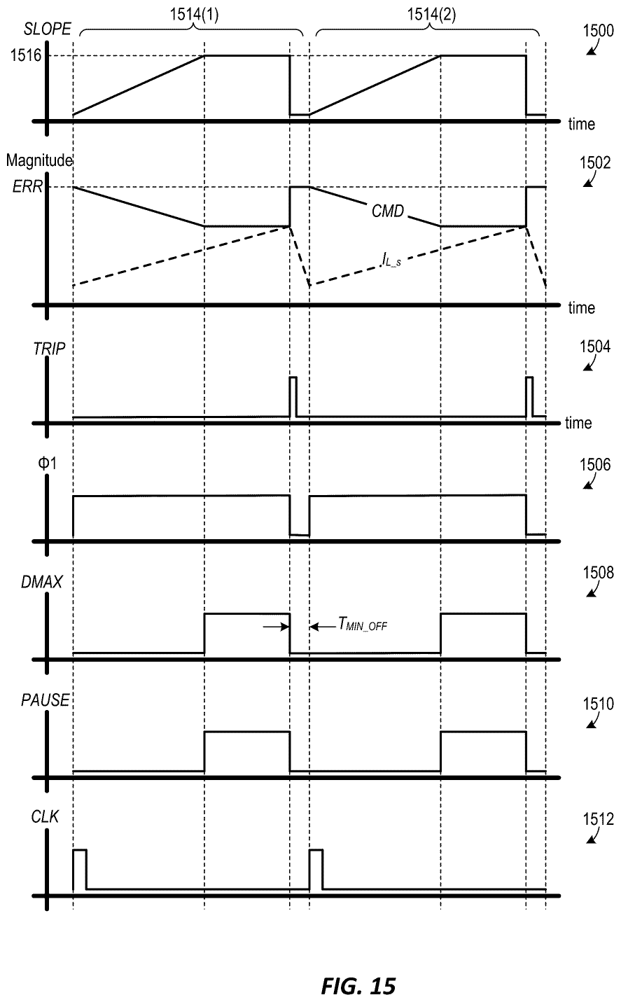

FIG. 15 includes seven graphs 1500, 1502, 1504, 1506, 1508, 1510, and 1512 collectively illustrating two consecutive switching cycles 1514 in another example of operation of DC-to-DC converter 404 including an embodiment of controller 1300. Graphs 1500, 1502, 1504, 1506, 1508, 1510, and 1512 are analogous to graphs 1400, 1402, 1404, 1406, 1408, 1410, and 1412 of FIG. 14, respectively. However, in contrast to the example of FIG. 14, magnitude of current flowing through the inductor of power stage 408 does not reach a threshold value defined by command signal CMD before exceeding a maximum permissible duty cycle of control switching device 422, in each switching cycle 1514. Accordingly, control signal ϕ1 and duty cycle signal DMAX are simultaneously asserted in each switching cycle 1514, and signal PAUSE is therefore asserted in each switching cycle 1514, in the FIG. 15 example. It should be noted that slope compensation signal SLOPE is maintained at a constant value 1516 while signal PAUSE is asserted, where constant value 1516 is equal to the last value of slope compensation signal SLOPE before signal PAUSE is asserted. It is understood, though, that when signal PAUSE is asserted, slope compensation signal SLOPE can alternately have a profile other than a constant value, e.g., assertion of signal PAUSE could slow ramp rate of slope compensation signal SLOPE instead of causing the signal to remain at a constant value.

In the FIG. 15 example, the constant value of slope compensation signal SLOPE resulting from assertion of signal PAUSE causes magnitude of command signal CMD to remain constant while signal PAUSE is asserted (assuming that output voltage Vₒᵤₜ does not materially change during a given switching cycle 1514), allowing control signal ϕ1 to remain asserted and control switching device 422 to remain in its on-state until magnitude of signal I_{L_s} reaches magnitude of command signal CMD. Consequently, DC-to-DC converter 404 operates in a constant off-time operating mode, where duration of the constant off-time is equal to T_{MIN_OFF}, in the FIG. 15 example. Operation in the constant off-time operating mode increases control switching device 422 on-time in each switching cycle, which allows magnitude of current flowing through the inductor of power stage 408 to reach the threshold value defined by command signal CMD. Operation in the constant off-time operating mode also deceases DC-to-DC converter 404 switching frequency, relative to operation in the constant frequency operating mode.

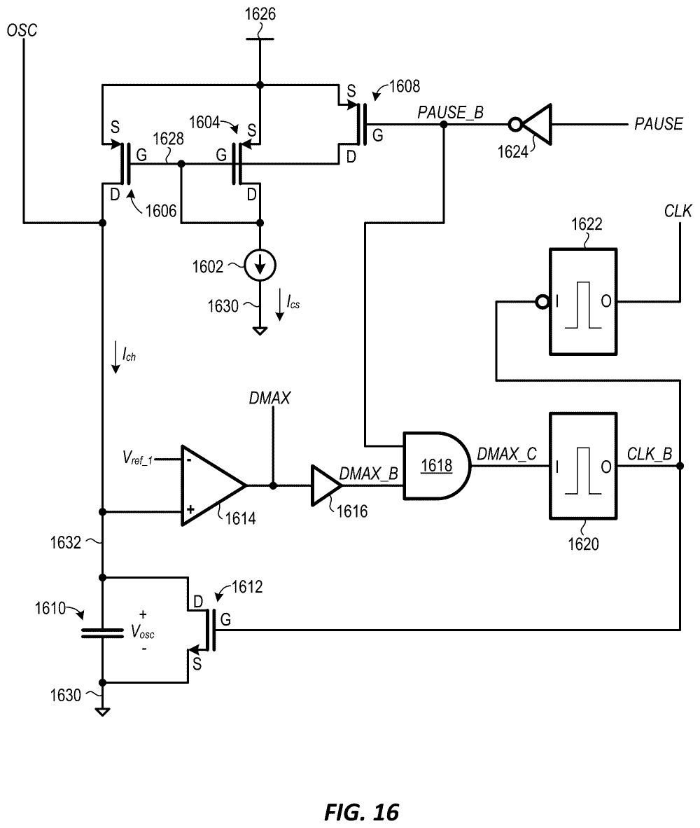

FIG. 16 is a schematic diagram of an oscillator 1600, which is one possible embodiment of oscillator 1302 (FIG. 13). It is understood, though, that oscillator 1302 could be embodied in manners other than that of FIG. 16.

Oscillator 1600 includes a current source 1602, a p-channel metal oxide field effect transistor (PMOS) 1604, a PMOS 1606, a PMOS 1608, a capacitor 1610, an n-channel metal oxide field effect transistor (NMOS) 1612, a comparator 1614, a delay buffer 1616, an AND gate 1618, a pulse generator 1620, a pulse generator 1622, and an inverter 1624. A source (S) of PMOS 1604 is electrically coupled to a power rail 1626, and each of a gate (G) and drain (D) of PMOS 1604 is electrically coupled to an electric node 1628. Current source 1602 is electrically coupled between electric node 1628 and a reference electric node 1630. A source of PMOS 1608 is electrically coupled to power rail 1626, and a drain of PMOS 1608 is electrically coupled to electric node 1628. A source of PMOS 1606 is electrically coupled to power rail 1626, and a gate of PMOS 1606 is electrically coupled to electric node 1628. A drain of PMOS 1606 is electrically coupled to an oscillator electric node 1632, and capacitor 1610 is electrically coupled between oscillator electric node 1632 and reference electric node 1630. Oscillator electric node 1632 provides oscillator signal OSC. A drain of NMOS 1612 is electrically coupled to oscillator electric node 1632, and a source of NMOS 1612 is electrically coupled to reference electric node 1630.

A non-inverting input of comparator 1614 is electrically coupled to oscillator electric node 1632, and an inverting input of comparator 1614 is electrically coupled to a reference voltage V_{ref_1}. An output of comparator 1614 provides duty cycle signal DMAX, and the output of comparator 1614 is also electrically coupled to an input of delay buffer 1616. An output of delay buffer provides a signal DMAX_B, which is electrically coupled to an input of AND gate 1618. An input of inverter 1624 receives signal PAUSE, and an output of inverter 1624 provides a signal PAUSE_B. Signal PAUSE_B is electrically coupled to each of a gate of PMOS 1608 and another input of AND gate 1618. An output of AND gate 1618 provides a signal DMAX_C which is electrically coupled to an input (I) of pulse generator 1620. An output (O) of pulse generator 1620 provides a signal CLK_B which is electrically coupled to each (a) a gate of NMOS 1612 and (b) an input of pulse generator 1622. An output of pulse generator 1622 provides clock signal CLK.

Signal PAUSE_B is asserted when signal PAUSE is de-asserted, and PMOS 1608 is therefore off when signal PAUSE is de-asserted. Therefore, PMOS 1608 does not affect operation of PMOS 1604 or PMOS 1606 when signal PAUSE is de-asserted. PMOS 1604 and PMOS 1606 collectively mirror a current I_{cs} of current source 1602 to generate a current Ich which charges capacitor 1610. Oscillator signal OSC is equal to a voltage V_{oc} across capacitor 1610, and oscillator signal OSC therefore ramps up as current Ich charges capacitor 1610. Comparator 1614 asserts duty cycle signal DMAX when voltage V_{oc} reaches reference voltage V_{ref_1}, and a duty cycle where a transition between the constant frequency operating mode of DC-to-DC converter 404 and the constant off-time operating mode of DC-to-DC converter 404 occurs is therefore a function of the magnitude of reference voltage V_{ref_1}, capacitance of capacitor 1610, and magnitude of current I_{ch}. Delay buffer 1616 delays asserts signal DMAX_B after a delay following comparator 1614 asserting signal duty cycle signal DMAX, and AND gate 1618 asserts signal DMAX_C when (a) signal DMAX_B is asserted and signal PAUSE is de-asserted. Pulse generator 1620 asserts signal CLK_B in response to signal DMAX_C being asserted, and asserted signal CLK_B is a pulse having a width equal to T_{MIN_OFF} (discussed above with respect to FIGS. 14 and 15). Signal CLK_B being asserted turns on NMOS 1612 which discharges capacitor 1610, thereby resetting oscillator signal OSC. Additionally, a falling edge of signal CLK_B causes pulse generator 1622 to assert clock signal CLK, where clock signal CLK is another pulse.

Assertion of signal PAUSE turns on PMOS 1608, which causes each of PMOS 1604 and PMOS 1606 to turn off. Consequently, assertion of signal PAUSE disables current Ich charging capacitor, and voltage V_{oc} therefore stops ramping upward. Consequently, oscillator signal OSC remains constant at a last value of voltage V_{oc} before signal PAUSE was asserted. Additionally, assertion of signal PAUSE prevents AND gate 1618 from asserting signal DMAX_C, which disables generation of clock signals CLK_B and CLK and discharging of capacitor 1610 while signal PAUSE is asserted. As such, operation of oscillator 1600 is paused when signed PAUSE is asserted.

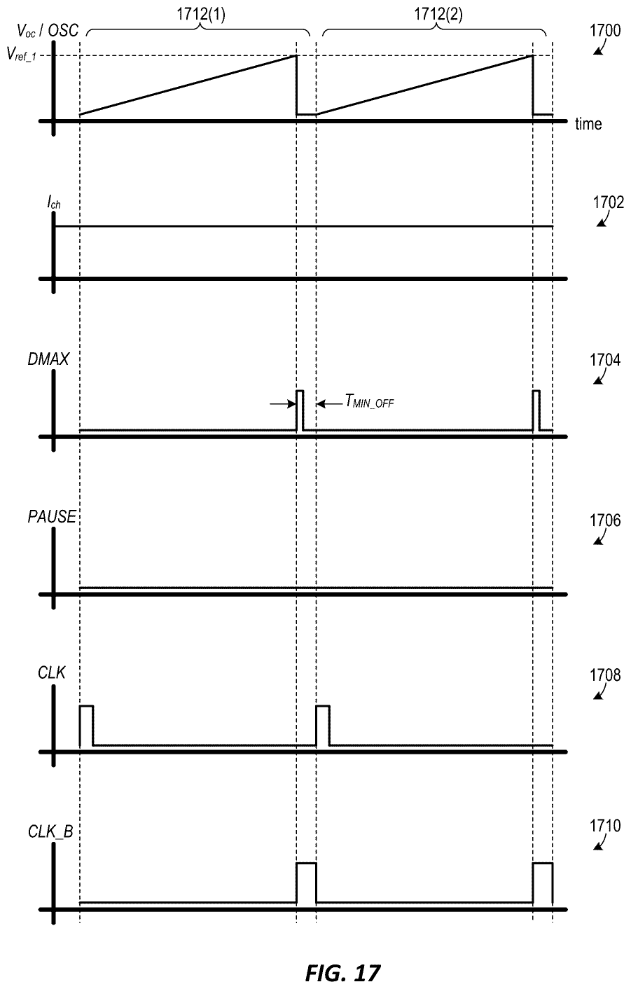

FIG. 17 includes six graphs 1700, 1702, 1704, 1706, 1708, and 1710 collectively illustrating one example of operation of oscillator 1600 over two consecutive switching cycles 1712 when signal PAUSE is not asserted. Graph 1700 is of voltage V_{OC} (and oscillator signal OSC) versus time, graph 1702 is of current I_{ch} charging capacitor 1610 versus time, graph 1704 is of duty cycle signal DMAX versus time, graph 1706 is of signal PAUSE versus time, graph 1708 is of clock signal CLK versus time, and graph 1710 is of signal CLK_B versus time. As shown in FIG. 17, current Ich is constant, resulting in voltage V_{c} ramping up until capacitor 1610 is discharged in response to assertion of signal CLK_B, in each cycle 1712.

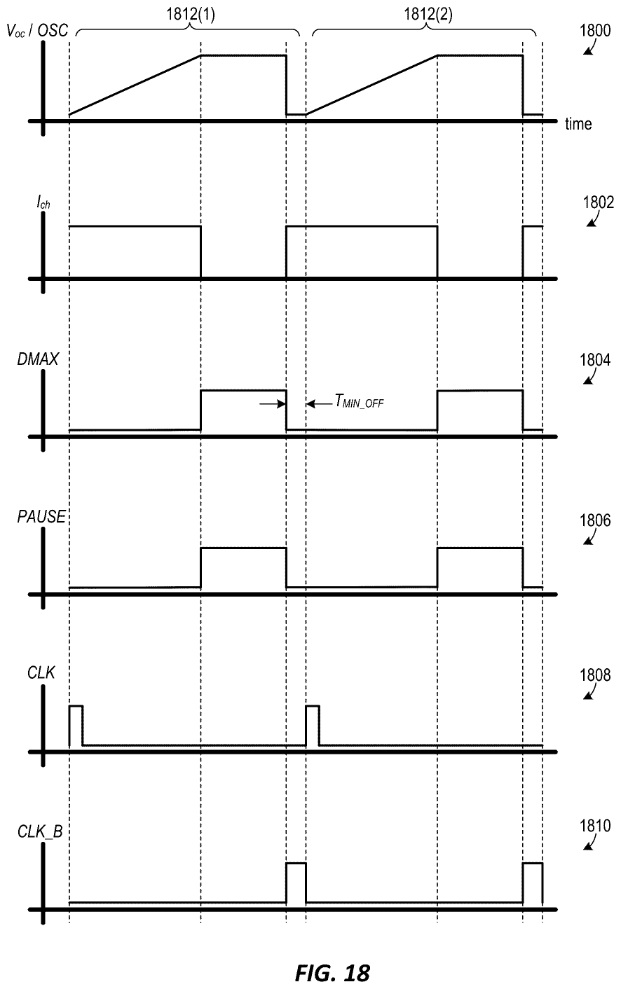

FIG. 18 includes six graphs 1800, 1802, 1804, 1806, 1808, and 1810 collectively illustrating one example of operation of oscillator 1600 over two consecutive switching cycles 1812 when signal PAUSE is asserted. Graphs 1800, 1802, 1804, 1806, 1808, and 1810 are analogous to graphs 1700, 1702, 1704, 1706, 1708, and 1710 of FIG. 17, respectively. As shown in FIG. 18, assertion of signal PAUSE disables current Ich charging capacitor 1610, and voltage V_{oc} (and oscillator signal OSC) therefore remain constant while signal PAUSE is asserted. Additionally, it should be noted that assertion of signal PAUSE inhibits signal CLK_B from being asserted, thereby inhibiting discharging of capacitor 1610 and assertion of clock signal CLK while signal PAUSE is asserted.

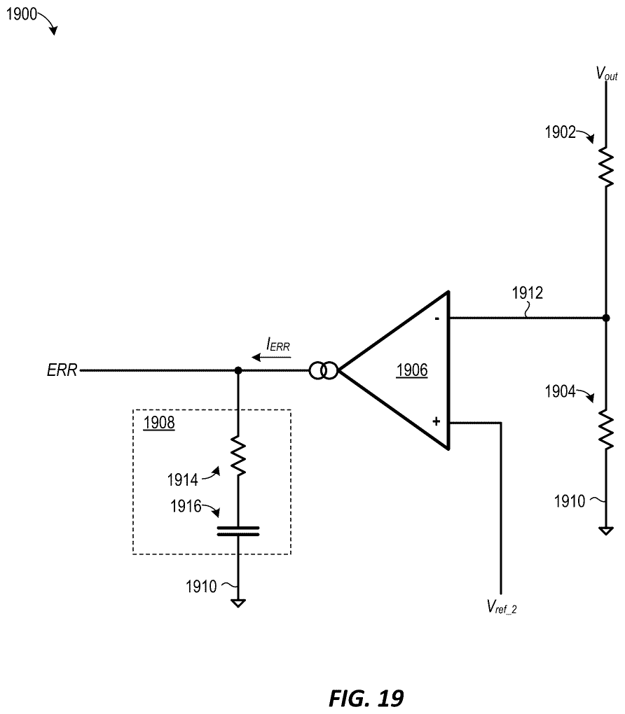

FIG. 19 is a schematic diagram of a voltage control module 1900, which is one possible embodiment of voltage control module 1306 (FIG. 13). It is understood, though, that voltage control module 1306 could be embodied in manners other than that of FIG. 19.

Voltage control module 1900 includes a resistor 1902, a resistor 1904, a transconductance amplifier 1906, and filter circuitry 1908. Resistor 1902 and resistor 1904 are electrically coupled in series between a node providing output voltage Vₒᵤₜ and a reference electric node 1910. An inverting input of transconductance amplifier 1906 is electrically coupled to a divider electric node 1912 where resistor 1902 and resistor 1904 are electrically coupled together. A non-inverting input of transconductance amplifier 1906 is electrically coupled to a reference voltage V_{ref_2}. Filter circuitry 1908 is electrically coupled between an output of transconductance amplifier 1906 and reference electric node 1910. Filter circuitry 1908 is illustrated as including a resistor 1914 electrically coupled in series with a capacitor 1916, although filter circuitry 1908 may vary as a design choice, such as to achieve a desired frequency response of voltage control module 1900. Filter circuitry 1906 integrates a current I_{ERR} flowing out of transconductance amplifier 1906 to generate error signal ERR. Transconductance amplifier 1906 generates current I_{ERR} in proportion to a difference between voltage at divider electric node 1912 and reference voltage V_{ref_2}. Accordingly, magnitude of output voltage Vₒᵤₜ is a function of both (a) a voltage divider formed by resistor 1902 and resistor 1904 and (b) reference voltage V_{ref_2}.

### Combinations of Features

Features described above may be combined in various ways without departing from the scope hereof. The following examples illustrate some possible combinations.

(A1) A method for controlling a direct-current-to-direct-current (DC-to-DC) converter, the method including, in a first switching cycle of the DC-to-DC converter, (1) causing the DC-to-DC converter to operate in a constant frequency operating mode, (2) determining that a duty cycle of a first switching device of the DC-to-DC converter has crossed a first threshold value, and (3) in response to the duty cycle of the first switching device of the DC-to-DC converter crossing the first threshold value, causing the DC-to-DC converter to switch from operating in the constant frequency operating mode to operating in a constant off-time operating mode.

(A2) In the method denoted as (A1), the first threshold value may be a maximum permissible duty cycle of the first switching device of the DC-to-DC converter in the constant frequency operating mode of the DC-to-DC converter.

(A3) In either one of the methods denoted as (A1) and (A2), causing the DC-to-DC converter to operate in the constant off-time operating mode may include changing operation of an oscillator of the DC-to-DC converter.

(A4) In the method denoted as (A3), changing operation of the oscillator of the DC-to-DC converter may include causing the oscillator to maintain an oscillator signal at a constant value while the DC-to-DC converter operates in the constant off-time operating mode.

(A5) In either of the methods denoted as (A3) and (A4), changing operation of the oscillator of the DC-to-DC converter may include extending a period of the oscillator.

(A6) Any one of the methods denoted as (A1) through (A5) may further include, in response to the duty cycle of the first switching device crossing the first threshold value, changing operation of a slope compensation module of the DC-to-DC converter.

(A7) In the method denoted as (A6), changing operation of the slope compensation module of the DC-to-DC converter may include causing the slope compensation module to maintain a slope compensation signal at a constant value while the DC-to-DC converter operates in the constant off-time operating mode.

(A8) Any one of the methods denoted as (A1) through (A7) may further include causing the first switching device to operate in its off-state, in response to magnitude of current flowing through an inductor of the DC-to-DC converter reaching a second threshold value.

(A9) Any one of the methods denoted as (A1) through (A8) may further include, in a second switching cycle of the DC-to-DC converter, causing the DC-to-DC converter to operate in the constant frequency operating mode for an entirety of the second switching cycle of the DC-to-DC converter, in response to the duty cycle of the first switching of the DC-to-DC converter not exceeding the first threshold value before the first switching device of the DC-to-DC converter switches to its off-state.

(B1) A controller for a direct-current-to-direct-current (DC-to-DC) converter includes (1) an oscillator configured to generate an oscillator signal, a clock signal, and a duty cycle signal, the duty cycle signal indicating that a maximum permissible duty cycle of a first switching device of the DC-to-DC converter has been exceeded, (2) a slope compensation module configured to generate a slope compensation signal at least partially based on the oscillator signal, (3) a switching control module configured to generate a control signal to control the first switching device at least partially based on the slope compensation signal and the clock signal, and (4) a mode change module configured to change operation of each of the oscillator and the slope compensation module in response to the duty cycle signal being asserted while the control signal is asserted.

(B2) In the controller denoted as (B1), the switching control module may be further configured to generate the control signal at least partially based on an error signal.

(B3) The controller denoted as (B2) may further include a voltage control module configured to generate the error signal at least partially based on a difference between a voltage of the DC-to-DC converter and a reference voltage.

(B4) In any one of the controllers denoted as (B1) through (B3), the switching control module may be further configured to generate the control signal based on a magnitude of current flowing through an inductor of the DC-to-DC converter.

(B5) In any one of the controllers denoted as (B1) through (B4), the maximum permissible duty cycle of the first switching device of the DC-to-DC converter may be a maximum permissible duty cycle of the first switching device of the DC-to-DC converter in a constant frequency operating mode of the DC-to-DC converter.

(B6) In any one of the controllers denoted as (B1) through (B5), the oscillator may be configured such that the DC-to-DC converter switches from a constant frequency operating mode to a constant off-time operating mode in response to assertion of the duty cycle signal.

(B7) In any one of the controllers denoted as (B1) through (B6), the oscillator may be configured such that a switching frequency of the DC-to-DC converter is reduced in response to assertion of the duty cycle signal.

(C1) A direct-current-to-direct-current (DC-to-DC) converter includes a power stage including a first switching device and a controller communicatively coupled to the power stage. The controller is configured to (1) cause the DC-to-DC converter to operate in a constant frequency operating mode, (2) determine that a duty cycle of the first switching device has crossed a first threshold value, and (3) in response to the duty cycle of the first switching device crossing the first threshold value, cause the DC-to-DC converter to switch from operating in the constant frequency operating mode to operating in a constant off-time operating mode.

(C2) In the DC-to-DC converter denoted as (C1), the first threshold value may be a maximum permissible duty cycle of the first switching device, in the constant frequency operating mode.

(C3) In either one of the DC-to-DC converters denoted as (C1) and (C2), the power stage may have a topology selected from the group consisting of a boost topology, a buck-boost topology, and a buck topology.

(C4) In any one of the DC-to-DC converters denoted as (C1) through (C3), (1) the controller may include an oscillator, (2) the controller may be further configured to cause the DC-to-DC converter to operate in the constant off-time operating mode at least partially by changing operation of the oscillator.

(C5) In the DC-to-DC converter denoted as (C4), changing operation of the oscillator may include disabling a current source charging a capacitor.

(C6) In either one of the DC-to-DC converters denoted as (C4) and (C5), changing operation of the oscillator may include extending a period of the oscillator.

(C7) In any one of the DC-to-DC converters denoted as (C1) through (C3), (1) the controller may include a slope compensation module, (2) the controller may be further configured to change operation of the slope compensation module in response to the duty cycle of the first switching device crossing the first threshold value.

(C8) In the DC-to-DC converter denoted as (C7), (1) the controller may further include an oscillator providing an oscillator signal to the slope compensation module, and (2) the controller may be further configured to change operation of the slope compensation module by changing operation of the oscillator.

Changes may be made in the above methods, devices, and systems without departing from the scope hereof. It should thus be noted that the matter contained in the above description and shown in the accompanying drawings should be interpreted as illustrative and not in a limiting sense. The following claims are intended to cover generic and specific features described herein, as well as all statements of the scope of the present method and system, which as a matter of language, might be said to fall therebetween.

What is claimed is:

1. A method for controlling a direct-current-to-direct-current (DC-to-DC) converter, the method comprising, in a first switching cycle of the DC-to-DC converter:
causing the DC-to-DC converter to operate in a constant frequency operating mode;
determining that a duty cycle of a first switching device of the DC-to-DC converter has crossed a first threshold value; and
in response to the duty cycle of the first switching device of the DC-to-DC converter crossing the first threshold value, causing the DC-to-DC converter to switch from operating in the constant frequency operating mode to operating in a constant off-time operating mode.

2. The method of claim 1, wherein the first threshold value is a maximum permissible duty cycle of the first switching device of the DC-to-DC converter in the constant frequency operating mode of the DC-to-DC converter.

3. The method of claim 1, wherein causing the DC-to-DC converter to operate in the constant off-time operating mode comprises changing operation of an oscillator of the DC-to-DC converter.

4. The method of claim 3, wherein changing operation of the oscillator of the DC-to-DC converter comprises causing the oscillator to maintain an oscillator signal at a constant value while the DC-to-DC converter operates in the constant off-time operating mode.

5. The method of claim 3, wherein changing operation of the oscillator of the DC-to-DC converter comprises extending a period of the oscillator.

6. The method of claim 1, further comprising, in response to the duty cycle of the first switching device crossing the first threshold value, changing operation of a slope compensation module of the DC-to-DC converter.

7. The method of claim 6, wherein changing operation of the slope compensation module of the DC-to-DC converter comprises causing the slope compensation module to maintain a slope compensation signal at a constant value while the DC-to-DC converter operates in the constant off-time operating mode.

8. The method of claim 1, further comprising causing the first switching device to operate in its off-state, in response to magnitude of current flowing through an inductor of the DC-to-DC converter reaching a second threshold value.

9. The method of claim 1, further comprising, in a second switching cycle of the DC-to-DC converter, causing the DC-to-DC converter to operate in the constant frequency operating mode for an entirety of the second switching cycle of the DC-to-DC converter, in response to the duty cycle of the first switching of the DC-to-DC converter not exceeding the first threshold value before the first switching device of the DC-to-DC converter switches to its off-state.

10. A controller for a direct-current-to-direct-current (DC-to-DC) converter, the controller comprising:
an oscillator configured to generate an oscillator signal, a clock signal, and a duty cycle signal, the duty cycle signal indicating that a maximum permissible duty cycle of a first switching device of the DC-to-DC converter has been exceeded;
a slope compensation module configured to generate a slope compensation signal at least partially based on the oscillator signal;
a switching control module configured to generate a control signal to control the first switching device at least partially based on the slope compensation signal and the clock signal; and
a mode change module configured to change operation of each of the oscillator and the slope compensation module in response to the duty cycle signal being asserted while the control signal is asserted.

11. The controller of claim 10, wherein the switching control module is further configured to generate the control signal at least partially based on an error signal.

12. The controller of claim 11, further comprising a voltage control module configured to generate the error signal at least partially based on a difference between a voltage of the DC-to-DC converter and a reference voltage.

13. The controller of claim 10, wherein the switching control module is further configured to generate the control signal based on a magnitude of current flowing through an inductor of the DC-to-DC converter.

14. The controller of claim 10, wherein the maximum permissible duty cycle of the first switching device of the DC-to-DC converter is a maximum permissible duty cycle of the first switching device of the DC-to-DC converter in a constant frequency operating mode of the DC-to-DC converter.

15. The controller of claim 10, wherein the oscillator is configured such that the DC-to-DC converter switches from a constant frequency operating mode to a constant off-time operating mode in response to assertion of the duty cycle signal.

16. The controller of claim 10, wherein the oscillator is configured such that a switching frequency of the DC-to-DC converter is reduced in response to assertion of the duty cycle signal.

17. A direct-current-to-direct-current (DC-to-DC) converter, comprising:
a power stage including a first switching device; and
a controller communicatively coupled to the power stage, the controller being configured to:
cause the DC-to-DC converter to operate in a constant frequency operating mode, determine that a duty cycle of the first switching device has crossed a first threshold value, and
in response to the duty cycle of the first switching device crossing the first threshold value, cause the DC-to-DC converter to switch from operating in the constant frequency operating mode to operating in a constant off-time operating mode.

18. The DC-to-DC converter of claim 17, wherein the first threshold value is a maximum permissible duty cycle of the first switching device, in the constant frequency operating mode.

19. The DC-to-DC converter of claim 17, wherein the power stage has a topology selected from the group consisting of a boost topology, a buck-boost topology, and a buck topology.

20. The DC-to-DC converter of claim 17, wherein:
the controller comprises an oscillator; and
the controller is further configured to cause the DC-to-DC converter to operate in the constant off-time operating mode at least partially by changing operation of the oscillator.
